(19) United States
(12) Patent Application Publication
(10) Pub. No.: US 2010/0110325 A1
(43) Pub. Date: May 6, 2010

(54) EDUCATIONAL KIT FOR DISPLAY DEVICE AND EDUCATIONAL METHOD UTILIZING THE SAME

(75) Inventors: An-Bang Wang, Taipei City (TW); Hsi-Chun Wang, Taipei City (TW); Jiun-Haw Lee, Taipei City (TW); Guo-Dung Su, Taipei City (TW); Lin-Chi Chen, Taipei City (TW); Ching-Heng Tang, Taipei County (TW); Kang-I Lin, Taipei City (TW)

Correspondence Address: QUINTERO LAW OFFICE, PC, 615 Hampton Dr, Suite A202, Venice, CA, 90291, US

(73) Assignee: NATIONAL TAIWAN UNIVERSITY, TAIPEI (TW)

(21) Appl. No.: 12/368,207

(22) Filed: Feb. 9, 2009

(30) Foreign Application Priority Data
Nov. 6, 2008 (TW) TW97142820

(51) Int. Cl. G02F 1/1333; G09B 19/00

(52) U.S. Cl. 349/58; 434/118

(57) ABSTRACT

An educational kit for a display device and an educational method utilizing the same is provided. The educational kit includes an upper housing, a lower housing, a display panel module and a circuit control panel. The display panel module is disposed between the upper housing and the lower housing. The circuit control panel is disposed between the display panel module and the lower housing. The method includes providing an educational kit for a display device; disassembling the display device into a plurality of components; and reassembling the components to form the display device. The educational method is accomplished by disassembling and reassembling the display device.

### CROSS REFERENCE TO RELATED APPLICATIONS

This Application claims priority of Taiwan Patent Application No. 097142820, filed on Nov. 6, 2008, the entirety of which is incorporated by reference herein.

### BACKGROUND OF THE INVENTION

1. Field of the Invention

The present invention relates to an educational kit for a display device and an educational method utilizing the educational kit.

2. Description of the Related Art

For a professional education of a display device, written descriptions, pictures, oral presentations and field trip to the manufactory are utilized to help students' understanding of the display device. However, it is still not clear enough for student to comprehend the working principles and the assembly method just by text books or slide shows. In addition, a visit to the manufactory does not help much because a safety distance must be kept during the manufacturing process that no contact is allowed during the visit. The above deficiencies may limit the dissemination of the professional education of a display device.

### BRIEF SUMMARY OF THE INVENTION

Accordingly, the present invention provides an educational kit for a display device. The educational kit comprises an upper housing, a lower housing, a display panel module and a circuit control panel. The display panel module is disposed between the upper housing and the lower housing. The circuit control panel is disposed between the display panel module and the lower housing. An educational method is accomplished by disassembling and reassembling the display device.

The invention provides an educational method. The method comprises providing an educational kit for a display device; disassembling the display device into a plurality of components; and reassembling the components to form the display device. The educational method is accomplished by disassembling and reassembling the display device.

### BRIEF DESCRIPTION OF THE DRAWINGS

The present invention can be more fully understood by reading the subsequent detailed description and examples with references made to the accompanying drawings, wherein:

FIG. 1 is a schematic view of an educational kit of the invention;

FIG. 2A is a flow chart showing an educational method of the invention;

FIG. 2B is a flow chart showing a detailed method of method M2 in FIG. 2A;

FIG. 2C is a flow chart showing a detailed method of method M8 in FIG. 2A;

FIG. 3 is a schematic view showing a backlight module and a circuit control panel of the invention;

FIG. 4 is a schematic view showing the backlight module, the circuit control panel and a brightness enhancement film of the invention;

FIG. 5 is a schematic view showing the backlight module, the circuit control panel and a diffusion film of the invention; and

FIG. 6 is a schematic view showing the backlight module, the circuit control panel and a liquid crystal display panel of the invention.

### DETAILED DESCRIPTION OF THE INVENTION

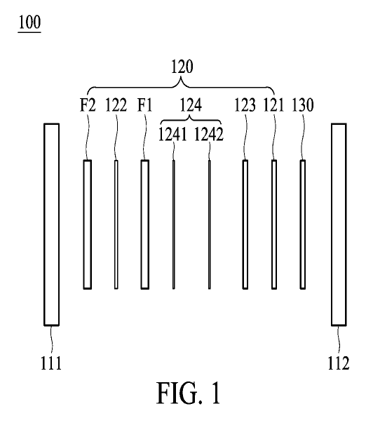

FIG. 1 is a schematic view of an educational kit of the invention. Referring to FIG. 1, the educational kit for a display device 100 comprises an upper housing 111, a lower housing 112, a display panel module 120 and a circuit control panel 130, wherein the educational kit is a 7-inch digital photo frame.

It should be noted that the educational kit 100 of the embodiment may further comprises a screwing member for connecting the above described components, or wires for coupling the above described components.

The display panel module 120 comprises a base 121, a liquid crystal display panel 122, a backlight module 123, two optical films 124 (a brightness enhancement film 1241 and a diffusion film 1242), a first frame F1 and a second frame F2. The liquid crystal display panel 122 is disposed in the base 121. The backlight module 123 is disposed between the liquid crystal display panel 122 and the base 121. The optical films 124 are disposed between the liquid crystal display panel 122 and the backlight module 123. The optical films 124 are secured on the backlight module 123 by the first frame F1, and the liquid crystal display panel 122 is secured on the backlight module 123 by the second frame F2.

The display panel module 120 is disposed between the upper housing 111 and the lower housing 112. The circuit control panel 130 is disposed between the display panel module 120 and the lower housing 112. Additionally, the circuit control panel 130 electrically connects to the liquid crystal display panel 122 and the backlight module 123 of the display panel module 120.

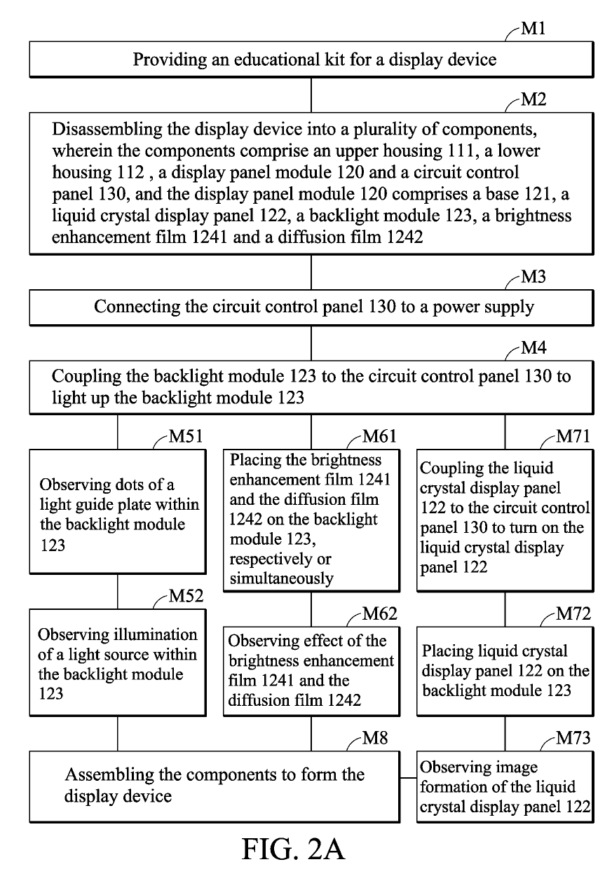

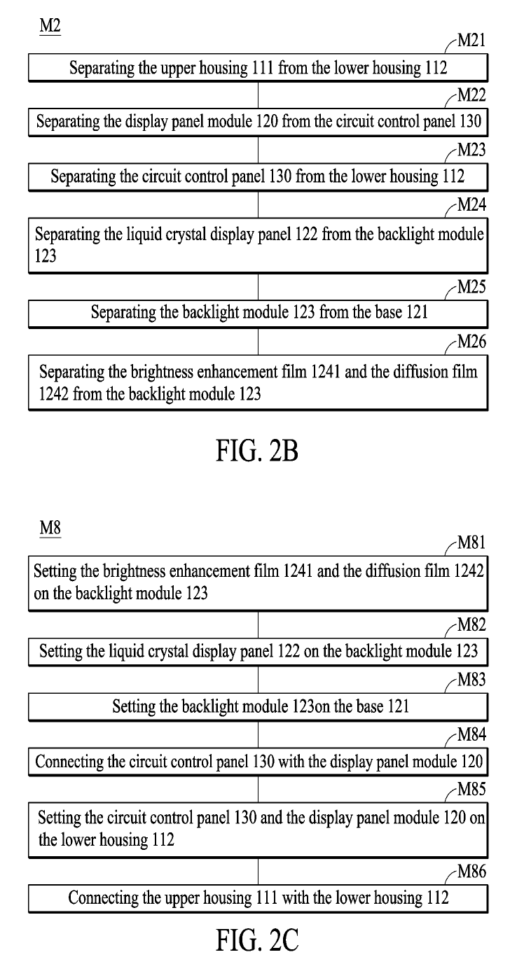

Furthermore, an educational method for assembly and experimentation of the display device can be performed during disassembly and reassembly of the display device. Referring to FIGS. 2A-2C, FIG. 2A is a flow chart showing an educational method of the invention, FIG. 2B is a flow chart showing a detailed method of method M2 in FIG. 2A, and FIG. 2C is a flow chart showing a detailed method of method M8 in FIG. 2A.

As shown in FIG. 2A, the educational method comprises M1˜ providing an educational kit for a display device, and M2˜ disassembling the display device into a plurality of components, wherein the components comprise an upper housing 111, a lower housing 112, a display panel module 120 and a circuit control panel 130, and the display panel module 120 comprises a base 121, a liquid crystal display panel 122, a backlight module 123, a brightness enhancement film 1241 and a diffusion film 1242 (as shown in FIG. 1).

As shown in FIG. 2B, the step of M2 comprises M21˜ separating the upper housing 111 from the lower housing 112, M22˜ separating the display panel module 120 from the circuit control panel 130, M23˜ separating the circuit control panel 130 from the lower housing 112, M24˜ separating the liquid crystal display panel 122 from the backlight module 123, M25˜ separating the backlight module 123 from the base 121, and M26˜ separating the brightness enhancement film 1241 and the diffusion film 1242 from the backlight module 123.

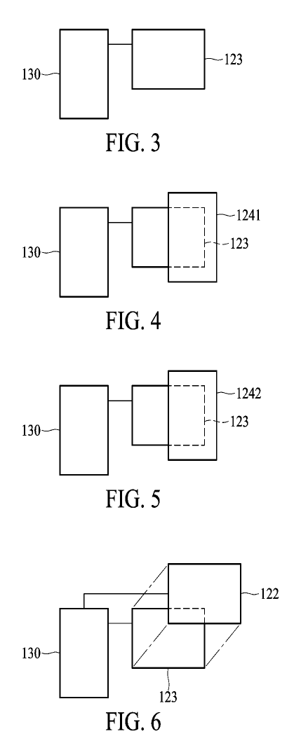

FIG. 3 is a schematic view showing a backlight module and a circuit control panel of the invention. FIG. 4 is a schematic view showing the backlight module, the circuit control panel and a brightness enhancement film of the invention. FIG. 5 is a schematic view showing the backlight module, the circuit control panel and a diffusion film of the invention. FIG. 6 is a schematic view showing the backlight module, the circuit control panel and a liquid crystal display panel of the invention.

Referring to FIG. 2A and FIGS. 3-6, the next steps are M3˜ connecting the circuit control panel 130 to a power supply, and M4˜ coupling the backlight module 123 to the circuit control panel 130 to light up the backlight module 123 (as shown in FIG. 3). Afterward, the following experiments can be performed. M51˜ observing dots of a light guide plate within the backlight module 123, M52˜ observing illumination of a light source within the backlight module 123, or M61˜ placing the brightness enhancement film 1241 and the diffusion film 1242 on the backlight module 123, respectively or simultaneously, and then M62˜ observing effect of the brightness enhancement film 1241 and the diffusion film 1242 (as shown in FIGS. 4 and 5). Otherwise, M71˜ coupling the liquid crystal display panel 122 to the circuit control panel 130 to turn on the liquid crystal display panel 122, M72˜ placing the liquid crystal display panel 122 on the backlight module 123, and M73˜ observing image formation of the liquid crystal display panel 122 (as shown in FIG. 6). During the above experimentations, students may use a magnifier, a microscope or the naked eye to inspect the microstructures of the liquid crystal display panel 122, the brightness enhancement film 1241, the diffusion film 1242 and the backlight module 123.

Lastly, the step of M8˜ reassembling the components to form the display device is accomplished after the above experiments. Referring to FIG. 2C, the step of M8 comprises M81˜ setting the brightness enhancement film 1241 and the diffusion film 1242 on the backlight module 123, M82˜ setting the liquid crystal display panel 122 on the backlight module 123, M83˜ setting the backlight module 123 on the base 121, M84˜ connecting the circuit control panel 130 with the display panel module 120, M85˜ setting the circuit control panel 130 and the display panel module 120 on the lower housing 112, and M86˜ connecting the upper housing 111 with the lower housing 112.

The educational kit has the ability to accomplish educational purposes of assembly and experimentation of a display device when disassembling and reassembling the educational kit. By bringing text explanations and photographs into practice, student's learning, motivations and interests may be raised to promote learning efficiency. Moreover, the low cost and the simple assembly of the educational kit allows mass usage within the area of study.

While the present invention has been described by way of example and in terms of preferred embodiment, it is to be understood that the present invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An educational kit for a display device comprising:
an upper housing;
a lower housing;
a display panel module disposed between the upper housing and the lower housing; and
a circuit control panel disposed between the display panel module and the lower housing,
wherein an educational method is accomplished by disassembling and reassembling the display device.

2. The educational kit as claimed in claim 1, wherein the display panel module comprises:
a base;
a liquid crystal display panel disposed in the base; and
a backlight module disposed between the liquid display panel and the base.

3. The educational kit as claimed in claim 2, wherein the display panel module further comprises a plurality of optical films disposed between the liquid crystal display panel and the backlight module.

4. The educational kit as claimed in claim 3, wherein the optical films comprises a brightness enhancement film and a diffusion film.

5. An educational method comprising:
providing an educational kit for a display device;
disassembling the display device into a plurality of components; and
assembling the components to form the display device,
wherein the educational method is accomplished by disassembling and reassembling the display device.

6. The educational method as claimed in claim 5, wherein the components comprise a circuit control panel and a display panel module, and the display panel module comprises a backlight module, a liquid crystal display panel and a plurality of optical films.

7. The educational method as claimed in claims 6, wherein the method further comprises:
connecting the circuit control panel to a power supply; and
coupling the backlight module to the circuit control panel to light up the backlight module.

8. The educational method as claimed in claims 7, wherein the method further comprises:
observing dots of a light guide plate within the backlight module; and
observing illumination of a light source within the backlight module.

9. The educational method as claimed in claim 7, wherein the method further comprises:
placing the optical films on the backlight module, respectively or simultaneously; and
observing effect of the optical films.

10. The educational method as claimed in claim 7, wherein the method further comprises:
coupling the liquid crystal display panel to the circuit control panel to turn on the liquid crystal display panel;
placing the liquid crystal display panel on the backlight module; and
observing image formation of the liquid crystal display panel.

11. The educational method as claimed in claim 5, wherein the components comprise:
an upper housing;
a lower housing;
a display panel module disposed between the upper housing and the lower housing; and
a circuit control panel disposed between the display panel module and the lower housing.

12. The educational method as claimed in claim 11, wherein the step of disassembling the display device into a plurality of components comprises:
separating the upper housing from the lower housing;
separating the display panel module from the circuit control panel; and
separating the circuit control panel from the lower housing.

13. The educational method as claimed in claim 11, wherein the step of reassembling the components to form the display device comprises:
connecting the circuit control panel with the display panel module;
setting the circuit control panel and the display panel module on the lower housing; and;
connecting the upper housing with the lower housing.

14. The educational method as claimed in claim 11, wherein the display panel module further comprises:
a base;
a liquid crystal display panel disposed in the base;
a backlight module disposed between the liquid display panel and the base; and
a plurality of optical films disposed between the liquid crystal display panel and the backlight module.

15. The educational method as claimed in claim 14, wherein the optical films comprises a brightness enhancement film and a diffusion film.

16. The educational method as claimed in claim 14, wherein the step of disassembling the display device into a plurality of components comprises:
separating the liquid crystal display panel from the backlight module;
separating the backlight module from the base; and
separating the optical films from the backlight module.

17. The educational method as claimed in claim 14, wherein the step of reassembling the components to form the display device comprises:
setting the optical film on the backlight module;
setting the liquid crystal display panel on the backlight module; and
setting the backlight module on the base.
